(19) United States
(12) Patent Application Publication
(10) Pub. No.: US 2003/0126432 A1
(43) Pub. Date: Jul. 3, 2003

(54) Content authentication for digital media based recording devices

(75) Inventor: Alan Valev Tonisson, Baulkham Hills (AU)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/315,033

(22) Filed: Dec. 10, 2002

(30) Foreign Application Priority Data
Dec. 21, 2001 (AU) PR9703

(51) Int. Cl. H04L 9/00

(52) U.S. Cl. 713/156

(57) ABSTRACT

Recording apparatus (100) is described that provides for content authentication. The apparatus (100) has a first storage media (109) for storing at least a digital certificate (115) and a pair of cryptographic keys comprising a private key (113), and a public key (114) corresponding to the private key. A recording arrangement (150, 101-105) operates to record event data (112) and a second storage media (108) is configured for storing at least the recorded event data. A signing processor (107) generates a digital signature (118) using at least the stored private key (113) and the recorded event data (112). A controller (160) is arranged to cause the apparatus to supply the stored public key (114) to a certificate generating authority (560), store (119) the digital certificate (115) in at least the second storage media (108), the certificate being formed using the public key (114) and supplied to the apparatus from the certificate generating authority (560), and to record the event data (112) and to associate a digital signature (118) generated by the signing processor (107) with the event data (112), thus forming an authenticable communications package (120). Also disclosed is method of authenticating recorded data received by way of the communication package (120). The method includes verifying (417) the certificate (119) using a public key (415) of the certifying authority (560), and verifying (411) the digital signature (118) and the public key (114, 413) of the apparatus (100). If both the certificate (119) and the signature (118) positively verify, the recorded event data (112) is said to be authentic.

### FIELD OF THE INVENTION

The present invention relates to digital media based devices for recording images and/or audio and, more particularly, to the digital signature based authentication of digitally recorded data and metadata associated with that data.

### BACKGROUND

Digital media based recording devices have become popular for recording high quality digital images and sounds. There are now numerous types of devices that record images and sounds on digital media. These include digital still cameras, digital video cameras and digital audio recording devices. Distinctions between these devices are becoming increasingly blurred over time. For example, many recent digital still cameras can record short motion sequences and record sound, and many digital video cameras can now record still images.

Digital cameras generally create a digital image by exposure of a charge-coupled device (CCD) sensor array to a photographic scene, followed by conversion of data generated by the CCD to digital image data that is stored on storage media, generally within the camera. Digital video recorders record motion video as a sequence of still images, which are typically compressed before being stored. Sound is recorded using a microphone and converted to digital data using an analogue to digital converter. Thereafter, the digital data stored in the device as one or more digital media files may be transferred to a personal computer or other more permanent storage for printout, listening, viewing, and transmission for example.

One problem with digitally recorded data however, is the ease with which such data can be manipulated or modified, thereby creating a false representation of the original scene or event. Such problems are particularly prevalent in certain fields such as forensics and legal or law enforcement fields, where it is essential to prove the authenticity of images or recorded sound. Because of the ease with which digital images and sounds may be altered to distort the appearance of the original recording, proof of authenticity can often be difficult, and sometimes impossible.

Conventional approaches to proving authenticity of digital data have involved the use of digital signatures based on public key/private key cryptography—also known as “asymmetric key cryptography”. Digital signatures are produced from digital data using a private key. This usually involves encrypting a hash of the data with the private key, in which the encrypted hash constitutes the digital signature. Digital signatures are designed so that they are, in practice, impossible to produce without knowledge of the private key. A digital signature can then be verified using the corresponding public key without knowledge of the private key. This is typically accomplished by decrypting the signature using the public key and comparing the resulting hash value with a hash calculated from the signed data. If the hash values match, then the signature is valid and proves that the signed data was in possession of the holder of the private key when it was signed.

When verifying a digital signature, it is necessary to be sure that the public key being used actually belongs to the claimed signer. One means of ascertaining the owner of a key is with a digital certificate. A digital certificate is an electronic document issued by a trusted party called a certification authority (CA) that asserts that a particular key belongs to a particular signer. The certificate contains information identifying the owner of the key, the public key itself and the digital signature of the CA. Digital certificates often contain other information, such as a serial number and expiration date. Digital certificates often conform to a standard format (eg. X.509), and may be kept in registries so that authenticating users can look up public keys of signers.

One application of digital signatures to digital media based recording devices is described in U.S. Pat. No. 6,269,446 (Schumacher et al.), which applies to digital cameras. Schumacher et al. improves on earlier work described in U.S. Pat. No. 5,499,294 (Friedman). The approach of Schumacher et al. involves the use of an embedded private key in a digital camera, with the private key being used to create a digital signature based on a message digest of the image data and associated metadata. In that instance, the metadata is derived from time and satellite (GPS) location information. Thereafter, a user wishing to authenticate the image data and its associated metadata obtains a public key that corresponds to the embedded private key. Through use of the public key, the user of the Schumacher et al. system is able to determine whether the digital image data has been modified since it was originally recorded by the digital camera.

One drawback of the Schumacher et al. system is that the authenticating software needs to have prior knowledge of the public key of each camera whose images are required to be authenticated. If a software application must authenticate images from multiple cameras, the user of the application must supply the public key of each camera to the software prior to attempting to authenticate images from each respective camera. This makes the Schumacher et al. system impractical if there are many cameras or many instances of the authentication software. In many applications, it may not be convenient for a user of the authentication software to obtain the key for every camera.

One solution is for the cameras to all have the same private key/public key pair, but such weakens the security of the system considerably. This solution is generally unacceptable because if the private key in any one camera is compromised, the whole system is compromised. Another solution is the use of a networked Public Key Infrastructure (PKI) involving one or more certificate authorities and public databases of keys and certificates. That solution has the disadvantage that it requires that the authenticating user has access to the public key/certificate databases. Further, that solution also requires the involvement of third party certificate authorities, which may be inconvenient for some applications.

### SUMMARY

It is an object of the present invention to substantially overcome, or at least ameliorate, one or more disadvantages of existing arrangements by providing an improved authentication arrangement for digital files, such as digital media files.

Authentication in this sense means to establish that data in the media file has not been modified since the data was recorded by the recording device. The term “media file” is thus used herein to refer to data recorded by a digital still camera, a digital video camera, a digital audio recorder or other digital recording device. A media file may also contain metadata associated with the recorded data. Such metadata is data that describes or provides information about the source data and its capture. This metadata may also be authenticated.

According to a first aspect of the invention, there is provided a method, in a data processing system which comprises a recording device and a certificate authority terminal, of determining if a file is modified or not, said method comprising the steps of:

generating a first public key and a first private key by the recording device;

transferring the first public key to the certificate authority terminal by the recording device;

encoding a certificate including the first public key received from the recording device by using a second private key by the certificate authority terminal;

transferring the encoded certificate to the recording device by the certificate authority terminal;

hashing said file to provide a digital signature by using the first private key in the recording device;

attaching the certificate received from the certificate authority terminal and the digital signature to said file in the recording device; and

distributing to a client terminal said file as a communication package assimilated at least said file, the digital signature and the certificate by the recording device.

According to another aspect of the invention, there is provided a processing system for determining if a file is modified or not, includes a recording device and a certificate authority terminal, said system comprising:

said recording device comprising:

a generator for generating a first public key and a first private key; and

a first transmitter for transferring the first public key to the certificate authority terminal;

said certificate authority terminal comprising:

an encoder for encoding a certificate including the first public key received from the recording device by using a second private key; and

a second transmitter for transferring the encoded certificate to the recording device;

said recording device further comprising:

a provider for hashing said file to provide a digital signature by using the first private key;

attaching means for attaching the certificate received from the certificate authority terminal and the digital signature to said file; and

a distributor for distributing to a client terminal said file as a communication package assimilated at least said file, the digital signature and the certificate.

According to a another aspect of the invention, there is provided apparatus comprising:

first storage media for storing at least a digital certificate and a pair of cryptographic keys comprising a private key, and a public key corresponding to said private key;

a recording arrangement for recording event data;

second storage media for storing at least said recorded event data;

a signing processor for generating a digital signature using at least said stored private key and said recorded event data; and

a controller arranged to cause said apparatus to:

(i) supply said stored public key to a certificate generating authority;

(ii) store said digital certificate in at least said second storage media, said certificate being formed using said public key and supplied to said apparatus from said certificate generating authority; and

(iii) record event data and to associate a digital signature generated by said signing processor with said event data.

According to another aspect of the invention, there is provided a device for processing data intended for subsequent authentication, said device comprising:

means for receiving a digital certificate generated from a private key of a certifying authority and incorporating a public key of said device;

means for generating a digital signature for said data and a private key of said device, said private key of said device complementing said public key of said device to collectively form a device key-pair; and

means for associating said data, said certificate and said digital signature as a communication package for transfer from said device.

According to another aspect of the invention, there is provided a method, in a recording device, of determining if a file is modified or not, said method comprising the steps of:

generating a first public key and a first private key;

transferring the first public key to a certificate authority terminal;

hashing said file to provide a digital signature by using the first private key;

attaching a certificate received from the certificate authority terminal and the digital signature to said file; and

distributing to a client terminal said file as a communication package assimilated at least said file, the digital signature and the certificate by the recording device,

wherein the certificate received from the certificate authority includes the first public key and is encoded by using a second private key generated in the certificate authority terminal.

According to another aspect of the invention, there is provided a storage medium storing a program for executing a process of determining if a file is modified or not, said program comprising the step of:

generating a first public key and a first private key;

transferring the first public key to a certificate authority terminal;

hashing said file to provide a digital signature by using the first private key;

attaching a certificate received from the certificate authority terminal and the digital signature to said file; and

distributing to a client terminal said file as a communication package assimilated at least said file, the digital signature and the certificate by the recording device,

wherein the certificate received from the certificate authority includes the first public key and is encoded by using a second private key generated in the certificate authority terminal.

Other aspects of the invention are also disclosed.

In an advantageous implementation, the digital recording device is equipped with not only the means for producing a media file either stored in an internal medium for later transmission or transmitted directly to an external digital storage medium, but also means for first generating a digital signature of all or part of the data in the media file, and the means for storing a digital certificate. Digital signatures generated by the device depend on a private key stored within the digital recording device. The private key is not known by anyone except perhaps the manufacturer of the digital recording device. To authenticate the data in a media file, the user needs to know the public key corresponding to the recording device's private key. To allow the software to obtain the public key and to ascertain that the public key is itself authentic, the public key and a digital certificate certifying the authenticity of the public key is added to the media file produced by the digital recording device. The certificate contains another digital signature certifying that the public key supplied is a valid public key corresponding to the private key stored in the digital recording device.

### BRIEF DESCRIPTION OF THE DRAWINGS

One or more embodiments of the present invention will now be described with reference to the drawings, in which:

FIG. 1A is a schematic block diagram representation of a structure of a recording device according to the present disclosure;

FIG. 1B is a functional block diagram representation of the recording device of FIG. 1A;

FIG. 2 illustrates the data and steps of creating and installing public and private keys and the certificate for the recording device of FIGS. 1A and 1B;

FIG. 3 shows in more detail the steps involved in producing and installing the keys and the certificate;

FIG. 4 illustrates the process of authenticating a digital media file produced by the digital recording device of FIGS. 1A and 1B; and

FIG. 5 is a schematic block diagram of a computer system upon which keys and certificates described can be generated for communication with the recording device of FIGS. 1A and 1B.

### DETAILED DESCRIPTION INCLUDING BEST MODE

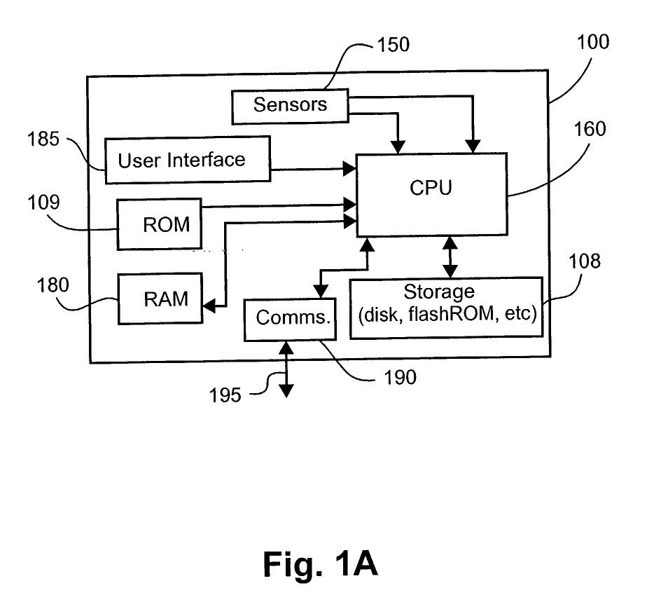

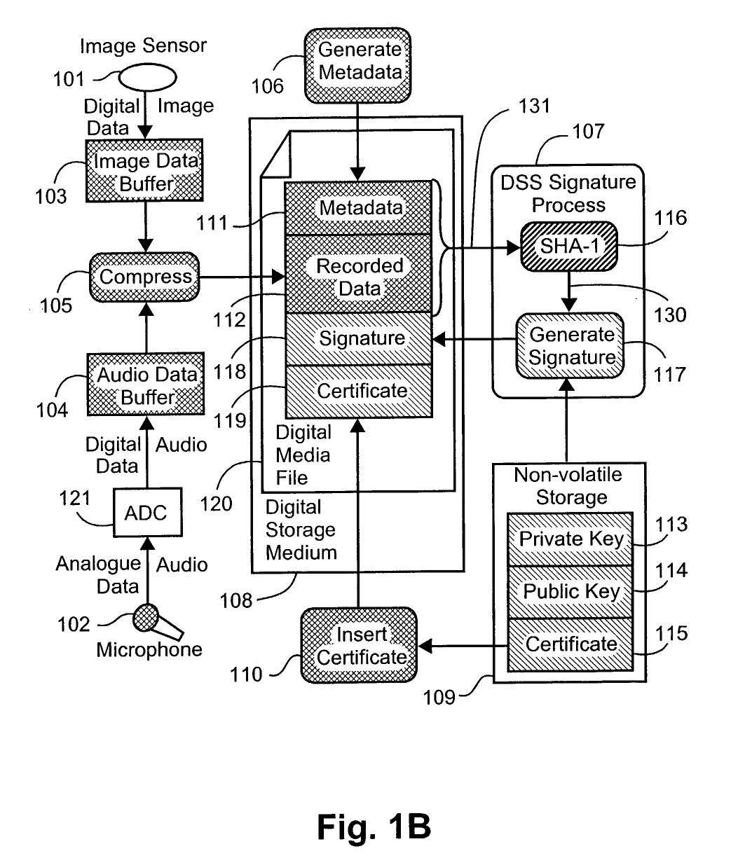

FIG. 1A shows a digital recording device 100 which includes sensors 150 for capturing images or audio, or both, intended for recording. The device 100 further includes a non-volatile recording medium such as a read-only memory (ROM) 109 for storing program instructions that control the operation of the device 100 via a processing unit (or CPU) 160, which reads and executes the instructions obtained from the ROM 109. The CPU 160 operates to extract captured image and audio information from the sensors 150 and format the same for retention in a non-volatile digital mass storage medium 108, which may be formed by a magnetic disk drive or magneto-optical drive, or flashROM for example. In some implementations, the functionality of the ROM 109 may be incorporated into the storage medium 108. A random access memory (RAM) 180 is also shown and provides the CPU 160 with a (volatile) intermediate storage capacity for key, signature and certificate processing. Image and audio data captured may be output from the recording device 100 via a communications module 190 to a external connection 195, which may be formed by wired or optical cable, or wireless methods such as radio frequency or infrared links. In some implementations, one or more of the components 160-190 may be formed in a single integrated circuit chip device.

FIG. 1B shows the main functional components of the recording device 100 and how such are used to produce a digital media file 120 for output via the connection 195. The digital recording device 100 incorporates an image sensor 101 and a microphone 102 for respectively detecting images and audio desired for recording and which, in the described arrangement, form the sensors 150 of FIG. 1A. Typically, the device 100 would also include a lens (not shown) to focus the light onto the sensor 101, the sensor 101 operating to produce digital luminance data that is stored temporarily in an image data buffer 103. The luminance data is typically formed of red, green and blue components. The luminance data is then preferably compressed using an appropriate compression function 105, such as JPEG, JPEG2000 or MPEG and the resulting compressed data 112 stored as part of the digital media file 120 in the digital storage medium 108. As illustrated, audio information can be simultaneously detected by the microphone 102 and converted to digital audio data by an analogue to digital converter (ADC) 121 before being temporarily stored in an audio data buffer 104. The audio data is also compressed using an appropriate compression function 105, such as MP3, and is also added to the recorded data 112 as part of the digital media file 120. The buffers 103 and 104 may be implemented using the RAM 180 or dedicated memories and the compression functions may, as appropriate, be performed by the CPU 160 or specific hardware devices (not illustrated). In other implementations, the image buffer 103 or audio buffer 104 may not be present and the audio and image data is compressed and written directly to the digital storage medium 108. In further implementations, the compression function 105 may be omitted, such that the recorded data 112 is formed by uncompressed audio and/or image data. In some implementations, the microphone 102, ADC 121, and the audio data buffer 104 may not be present; and in other implementations, the image sensor 101 and image data buffer 103 may not be present.

As shown in FIG. 1B, the recording device 100 includes a module 106 configured to generate metadata 111 associated with the recorded data 112. The metadata 111 may include the date and time that the data was recorded, the GPS location coordinates at which the recording took place, and other data specified by the user, such as exposure settings and text data input. The metadata 111 is stored as part of the digital media file 120. In some implementations, this facility may be omitted, and no metadata is stored in the digital media file 120.

A private key 113, public key 114 and digital certificate 115 are preferably stored in non-volatile but re-writable storage, such as flash ROM, which may be used to form the storage 108, or part thereof. That data may alternatively be stored in the ROM 109, where such would not be able to be altered or changed, however such has the disadvantage that it prevents a change in certificate authorities, or having a local certificate authority maintained by the user. Such also makes the manufacturer responsible for managing keys and forces the user to trust the manufacturer with the key generation. For these reasons, it is preferable to have the device 100 generate new keys on demand, which necessitates the keys 113, 114 and certificate 115 being re-writable. The private key 113 may optionally be stored in tamper-proof hardware in high-end high-security applications. The public key 114 is typically included in the certificate 115 and so a separately stored copy of the public key, as indicated at 114 in FIG. 1B, is not strictly necessary. However, separately storing the public key 114 from the certificate 115 allows for the possibility of not using the certificate 115. In this fashion, use of the certificate 115 is optional, and such allows the recording device 100 to be ignorant of the format of the certificate 115.

As also illustrated in FIG. 1B, the CPU 160 operates to perform a process 107 in which the private key 113 is used by a generate signature sub-process 117 to produce a digital signature 118 which is stored as part of the digital media file 120. Preferably, the digital signature process 107 conforms to the known Digital Signature Standard (DSS) specified by the United States National Institute of Standards and Technology (NIST). The process 107 also involves the CPU 160 computing an SHA-1 hash function 116 of the data to be signed, which provides a hash result 130. The hash function 116 is followed by the signature generation process 117, which in practice encrypts the hash result 130 with the private key 113. In the arrangement illustrated, the data that is signed includes the recorded data 112 and the associated metadata 111, illustrated collectively as data 131. In other implementations, the signed data 131 may not include all of the recorded data 112 and may not include all of the associated metadata 111.

As also depicted in FIG. 1B, the CPU 160, well as adding the generated signature 118 to the digital media file 120, also adds a copy 119 of the certificate 115 to the digital media file 120, this being indicated by an insert certificate function 110.

In a typical physical implementation, the compression function 105 and SHA-1 hash function 116 are preferably performed by application specific integrated circuits, whereas the remaining functions may be conveniently implemented by the CPU 160.

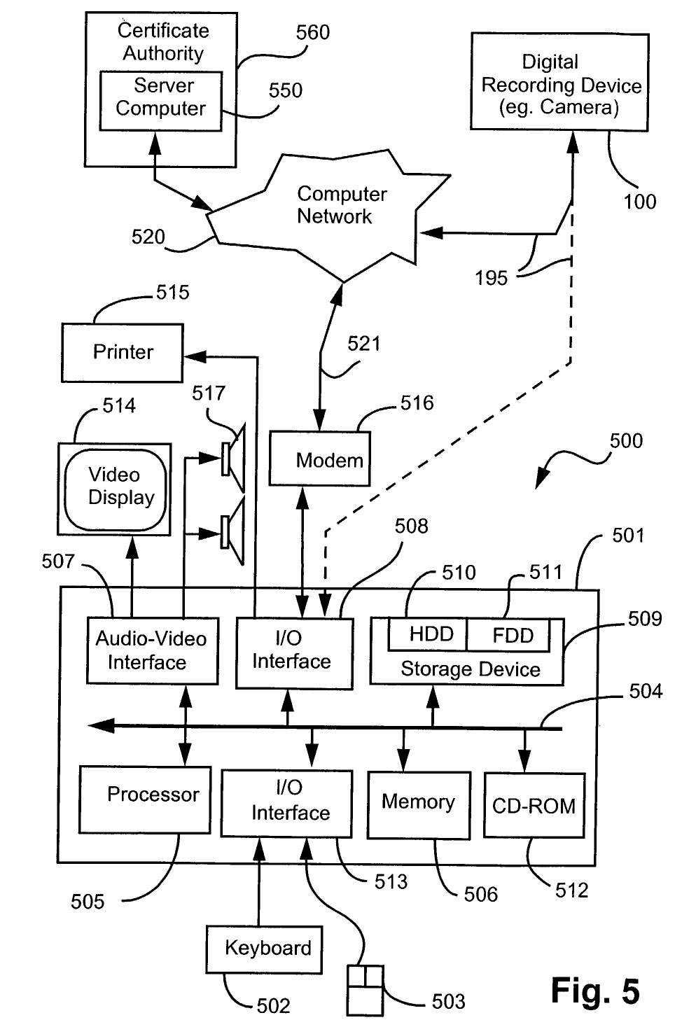

Once formed by the recording device 100, the digital media file 120, comprising the metadata 111, recorded data 112, signature 118 and certificate 119 may be output from the device 100 by the CPU 160. Such can thereby cause transfer of the file 120 from the storage 108 via the communications module 190 and link 195 to a computer system 500, as shown in FIG. 5. As illustrated, the link 195 may be direct (via the dashed line) or via a computer network 520.

Preferably, authentication of the recorded data 112 and metadata 111 is performed by a software application running on the general-purpose computer system 500, wherein the authentication processes may be implemented as software, such as an application program executing within the computer system 500. In particular, the steps of the process are effected by instructions in the software that are carried out by the computer. The instructions may be formed as one or more code modules, each for performing one or more particular tasks. The software may also be divided into two separate parts, in which a first part performs the authentication methods and a second part manages a user interface between the first part and the user. The software may be stored in a computer readable medium, including the storage devices described below, for example. The software is loaded into the computer from the computer readable medium, and then executed by the computer. A computer readable medium having such software or computer program recorded on it is a computer program product. The use of the computer program product in the computer preferably effects an advantageous apparatus for authenticating recorded data.

The computer system 500 comprises a computer module 501, input devices such as a keyboard 502 and mouse 503, output devices including a printer 515, a display device 514 and loudspeakers 517. A Modulator-Demodulator Modem transceiver device 516 is used by the computer module 501 for communicating to and from a communications network 520, for example connectable via a telephone line 521 or other functional medium. The modem 516 can be used to obtain access to the Internet, and other network systems, such as a Local Area Network (LAN) or a Wide Area Network (WAN). Where appropriate, a network card (not illustrated) may form part of the I/O interface 508 for direct connection between the computer module 501 and a LAN or WAN.

The computer module 501 typically includes at least one processor unit 505, a memory unit 506, for example formed from semiconductor random access memory (RAM) and read only memory (ROM), input/output (I/O) interfaces including a audio-video interface 507 for the display 514 and loudspeakers 517, and an I/O interface 513 for the keyboard 502 and mouse 503 and optionally a joystick not illustrated, and an interface 508 for the modem 516 or direct device connection, as illustrated. A storage device 509 is provided and typically includes a hard disk drive 510 and a floppy disk drive 511. A magnetic tape drive not illustrated may also be used. A CD-ROM drive 512 is typically provided as a non-volatile source of data. The components 505 to 513 of the computer module 501, typically communicate via an interconnected bus 504 and in a manner which results in a conventional mode of operation of the computer system 500 known to those in the relevant art. Examples of computers on which the described arrangements can be practised include IBM-PC's and compatibles, Sun Sparcstations or alike computer systems evolved therefrom.

Typically, the application program is resident on the hard disk drive 510 and read and controlled in its execution by the processor 505. Intermediate storage of the program and any data fetched from the network 520 may be accomplished using the semiconductor memory 506, possibly in concert with the hard disk drive 510. In some instances, the application program may be supplied to the user encoded on a CD-ROM or floppy disk and read via the corresponding drive 512 or 511, or alternatively may be read by the user from the network 520 via the modem device 516. Still further, the software can also be loaded into the computer system 500 from other computer readable media. The term “computer readable medium” as used herein refers to any storage or transmission medium that participates in providing instructions and/or data to the computer system 500 for execution and/or processing. Examples of storage media include floppy disks, magnetic tape, CD-ROM, a hard disk drive, a ROM or integrated circuit, a magneto-optical disk, or a computer readable card such as a PCMCIA card and the like, whether or not such devices are internal or external of the computer module 501. Examples of transmission media include radio or infra-red transmission channels as well as a network connection to another computer or networked device, and the Internet or Intranets including email transmissions and information recorded on websites and the like.

The method of authentication may alternatively be implemented in dedicated hardware such as one or more integrated circuits performing the functions or sub functions of authentication. Such dedicated hardware may include graphic, processors, digital signal processors, or one or more microprocessors and associated memories.

With the digital media file 120 downloaded to the computer module 501 and, for example, stored in the HDD 510, the certificate 119 allows the authentication application to authenticate the digital media files including the data 111 and 112 without having prior knowledge of the public key 114 of the device 100 that recorded the data 111 and 112.

The simplest way to achieve this is to use the same certificate authority to produce certificates for all recording devices whose images will be authenticated by a given authenticator. Authentication can then be performed using only the public key of the certificate authority. Even where it is not practical to use a single certificate authority, the use of certificates can reduce the number of public keys that the authenticators (ie. the computer 500, the authentication application and its users) need to trust. In the preferred implementation, the public keys of the one or more certificate authorities are stored in the software that is used for authentication. Such software may be obtained from the certificate authority for example by a user of the computer system 500 downloading the software from a server computer 550 operated by the certificate authority 560 and connected to the network 520, as illustrated in FIG. 5.

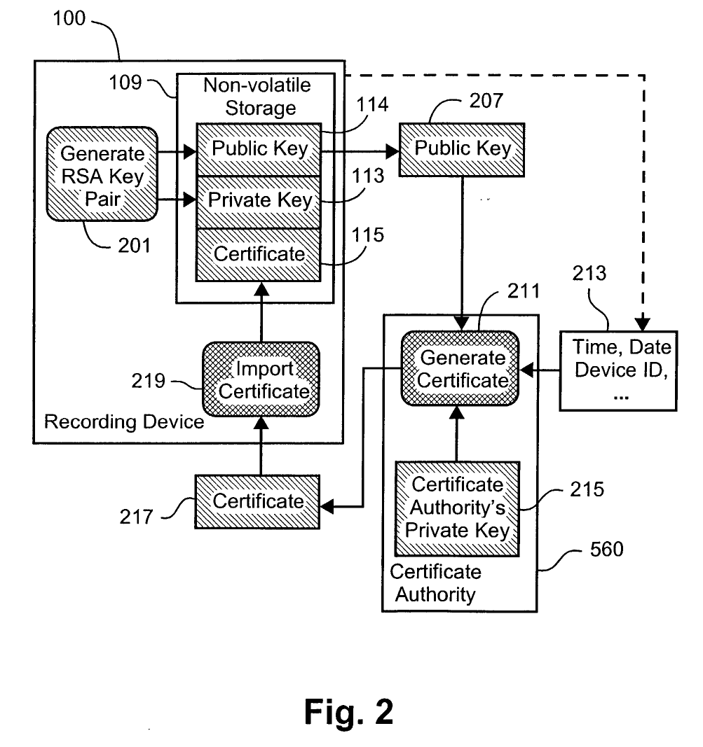

FIG. 2 shows the steps involved in creating the public and private keys and the certificate. As shown in FIG. 2, the recording device 100 has a further function 201 for generating an encryption/decryption key pair formed of the public key 114 and a private key 113. The keys 113 and 114 preferably constitute an RSA private key/public key pair of length 2048 bits or longer. Alternatively, keys for other encryption algorithms may be used. For example, an elliptic curve encryption algorithm may be used instead of RSA. In other implementations, the keys 113 and 114 may be generated by the manufacturer of the device 100 and embedded in the device 100 together with the certificate 115 during the manufacturing process. However, preferably, the keys 113 and 114 are generated by the recording device 100 and are stored in non-volatile storage media 109.

The recording device 100 provides to a user thereof a means of accessing the stored public key 114, so that, as seen in FIG. 2, the user can send a copy 207 of the public key 114 to a certificate authority 560 for certification. The certificate authority 560 operates a function 211, for example in the server computer 550, to generate a digital certificate 217 which can be supplied to the user using an import certificate function 219 of the recording device 100, which can then be stored as the certificate 115 described above. The certificate 217 is created using a private key 215 of the certificate authority 560. Again, preferably, the certificate 217 conforms to the X.509 standard. Advantageously, the recording device 100 does not parse or check the certificate 217 as such is imported, and thus more than one certificate format, including future formats that may not yet have been conceived, may be supported without modifications to the recording device 100. The user of the recording device 100 typically also supplies the certificate authority 560 with information 213 that is associated with the public key 114, 207. In this regard, the certificate 217 may contain miscellaneous information about the owner of the key 114, 207 such as the time the certificate 217 was created. The owner of the key 114, 207 must convince the certificate authority 560 that the information certified by the certificate 217 is correct and, in particular, that the public key 114, 207 corresponds to a private key 115 owned by the user. In the described embodiment, this may be effected by the owner of the device 100 showing the device 100 to the certificate authority 560 and showing the public key 114, 207 presented by the device 100. The term “owner” in relation to the key 114, 207 may either mean the *device* itself or the *person* owning the device. Such depends on what the certificate 217 is operating to certify. Either alternative may be used in some applications. Preferably, the information 213 includes at least the unique serial number (or device ID) of the recording device 100 and proof that the public key 207 was generated by the device 100 with the supplied serial number is given to the certificate authority 560. The serial number of the recording device 100 can thus be included in the certificate 217, as described previously. In other implementations, other information may be supplied to identify the owner of the public key 207. In order to transfer the key 207 and information 213, the recording device 100 may utilize the computer system 500 or a different computer network as an intermediary, for example where the direct connection 195 to the I/O interface 508 is used. Alternatively, and dependent upon the level of sophistication of the communications module 190, communications between the device 100 and server 550 may be established directly via the network 520. Alternatively, keys may be manually input into the server 550.

Once the device 100 has stored a copy of the certificate 217 as the certificate 115, the recording device 100 will then be ready to record data that can be authenticated.

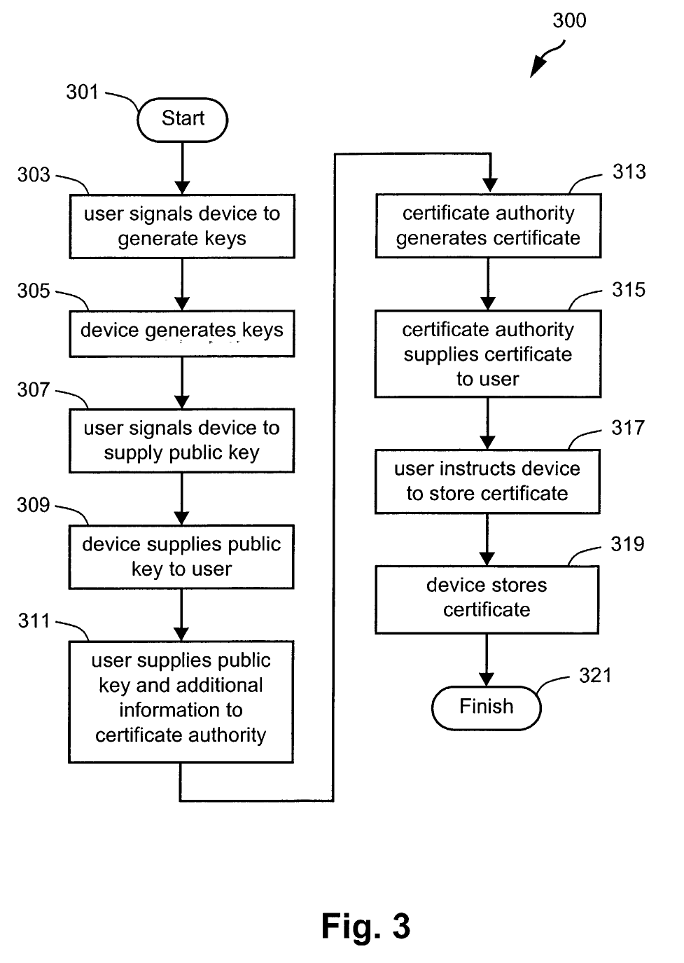

FIG. 3 summarises, as a flowchart, a method 300 involved in producing and installing the keys and the certificate. The method 300 may be implemented typically as a number of software programs operating on the recording device 100, the CA server 550 and possibly in concert with the computer system 500 and which operate in response to various user actions, and which have a nominal entry point as a start step 301. In step 303 which follows, the user signals the device 100 to generate a key pair. This is performed using an appropriate user interface 185 arranged on the device 100, seen in FIG. 1A. In step 305, the recording device 100 generates the key pair 113, 114, this being accomplished using the function 201 seen in FIG. 2. In step 307, again manipulating the user interface 185, the user signals the device 100 to supply the generated public key 114 for user dissemination. In response, in step 309, the device 100 delivers the copy 207 of the public key 114 to the user. This supply may be by way of the personal computer 500, or for example to a user accessible location in the RAM 180 of the device 100. In step 311, the user supplies the public key copy 207, from either the computer 500 or RAM 180, together with the additional information 213, to the certificate authority 560, for example by way of the server 550. At step 313, the certificate authority 560 using the function 215 of FIG. 2, generates the certificate 217 and at step 315, supplies the certificate 217 to the user. Again, this may occur via the computer 500 or directly to the RAM 180 of the device 100. At step 317, via the interface 185, the user instructs the device 100 to store the certificate 217 as the certificate 115, this being by way of the import certificate function 219 of FIG. 2. At step 319, the device 100 stores the certificate 115 and the method ends at step 321.

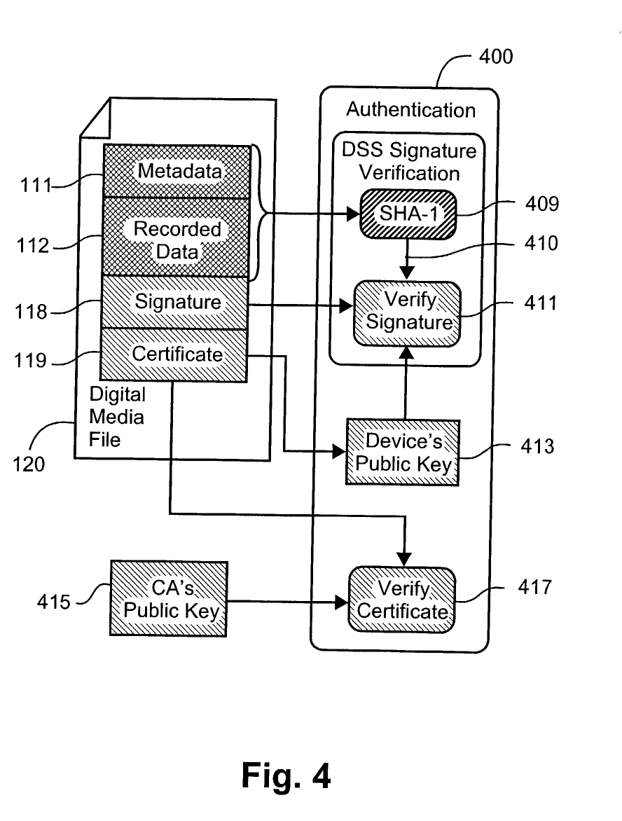

FIG. 4 shows the data and steps involved in authenticating the digital media file 120 according to a preferred implementation. These steps are preferably performed by a software application 400 running on the personal computer system 500 and includes two main independent processes involved in verifying the digital media file 120, that has previously applied to the computer system 500, for example as described above. The first process operates to verify that the digital signature 118 is a valid signature. The second process operates to verifying that the certificate 119 contained in the file 120 is genuine. In the preferred implementation, the signature verification process conforms to the Digital Signature Standard (DSS). In other implementations, other digital signature schemes may be used.

The first process of verifying the digital signature 118 includes firstly calculating a hash of the metadata 111 and the recorded data 112 stored in the file 120. This hash is calculated using an SHA-1 algorithm 409 as specified by DSS. The resulting hash result 410 is used, together with an.,extracted version 413 of the public key 114 of the recording device 100, as inputs to a DSS signature verification process 411. The extracted public key 413 is obtained from the certificate 119 stored in the digital media file 120 and it will be recalled from the above that the public key 114 (207) was retained as part of the certificate 217,115,119. Verifying the signature is performed by a function 411 that operates to decrypt the signature 118 using the regenerated public key 413 and comparing the decrypted signature with the hash result 410. If the two are the same, the file 120 is authentic. The final verification step is also preferably performed in accordance with the DSS signature verification methodology.

The second process of verifying the certificate 119 is performed using a function 417 which verifies the digital signature on the certificate 119 using a public key 415 of the certificate authority 560. Such does not need the public key of the device 413. This is because what is desired is to check that the public key in the certificate matches the public key used to authenticate the file. In the described arrangement however, the public key (413) is obtained from the certificate 119, and thus there is no need to access that key 413 separately. The certificate 119 is verified using the public key 415 of the certificate authority 560, and the public key 114 (413) of the device 100 is just part of the data in the certificate 119. Preferably, the certificate 119 conforms to the X.509 certificate format and any digital signature scheme suitable for use with X.509 certificates may be used.

### Industrial Applicability

It is apparent from the above that the arrangements described are applicable to data capture and recording where verification of authenticity is desired. Such pervades the computer and data processing industries and has particular relevance to portable data capture devices, such as cameras, that may be connected to computer networks.

The foregoing describes only some embodiments of the present invention, and modifications and/or changes can be made thereto without departing from the scope and spirit of the invention, the embodiments being illustrative and not restrictive.

The present inventors and the present patent applicant note that the discussion in the “Background” section above regarding prior disclosures relates to those disclosures as merely public knowledge and such discussion is not to be construed as an admission by the inventors or the applicant that such disclosures represent all or part of the common general knowledge in the art in Australia or elsewhere.

We claim:

1. A method, in a data processing system which comprises a recording device and a certificate authority terminal, of determining if a file is modified or not, said method comprising the steps of:
generating a first public key and a first private key by the recording device;
transferring the first public key to the certificate authority terminal by the recording device;
encoding a certificate including the first public key received from the recording device by using a second private key by the certificate authority terminal;
transferring the encoded certificate to the recording device by the certificate authority terminal;
hashing said file to provide a digital signature by using the first private key in the recording device;
attaching the certificate received from the certificate authority terminal and the digital signature to said file in the recording device; and
distributing to a client terminal said file as a communication package assimilated at least said file, the digital signature and the certificate by the recording device.

2. A method according to claim 1, further comprising the steps, in the client terminal, of:
acquiring the first public key from the certificate by using a second public key received from the certificate authority terminal;
decoding the digital signature by using the first public key;
hashing said file to provide a hash; and
determining if said file is modified or not in accordance with the comparison between the hash and the digital signature.

3. A method according to claim 1, further comprising a step of generating metadata, and of associating said metadata with said file such that said digital signature additionally depends on said metadata.

4. A method according to claim 3, further comprising a step of receiving additional data entered by a user of said recording device, and of storing said additional data as part of said metadata.

5. A method according to claim 1, wherein said digital signature conforms to the DSS methodology.

6. A processing system for determining if a file is modified or not, includes a recording device and a certificate authority terminal, said system comprising:
said recording device comprising:
a generator for generating a first public key and a first private key; and
a first transmitter for transferring the first public key to the certificate authority terminal;
said certificate authority terminal comprising:
an encoder for encoding a certificate including the first public key received from the recording device by using a second private key; and
a second transmitter for transferring the encoded certificate to the recording device;
said recording device further comprising:
a provider for hashing said file to provide a digital signature by using the first private key;
attaching means for attaching the certificate received from the certificate authority terminal and the digital signature to said file; and
a distributor for distributing to a client terminal said file as a communication package assimilated at least said file, the digital signature and the certificate.

7. Apparatus comprising:
first storage media for storing at least a digital certificate and a pair of cryptographic keys comprising a private key, and a public key corresponding to said private key;
a recording arrangement for recording event data;
second storage media for storing at least said recorded event data;
a signing processor for generating a digital signature using at least said stored private key and said recorded event data; and
a controller arranged to cause said apparatus to:
(i) supply said stored public key to a certificate generating authority;
(ii) store said digital certificate in at least said second storage media, said certificate being formed using said public key and supplied to said apparatus from said certificate generating authority; and
(iii) record event data and to associate a digital signature generated by said signing processor with said event data.

8. A device for processing data intended for subsequent authentication, said device comprising:
means for receiving a digital certificate generated from a private key of a certifying authority and incorporating a public key of said device;
means for generating a digital signature for said data and a private key of said device, said private key of said device complementing said public key of said device to collectively form a device key-pair; and
means for associating said data, said certificate and said digital signature as a communication package for transfer from said device.

9. A method, in a recording device, of determining if a file is modified or not, said method comprising the steps of:
generating a first public key and a first private key;
transferring the first public key to a certificate authority terminal;
hashing said file to provide a digital signature by using the first private key;
attaching a certificate received from the certificate authority terminal and the digital signature to said file; and
distributing to a client terminal said file as a communication package assimilated at least said file, the digital signature and the certificate by the recording device,
wherein the certificate received from the certificate authority includes the first public key and is encoded by using a second private key generated in the certificate authority terminal.

10. A storage medium storing a program for executing a process of determining if a file is modified or not, said program comprising the step of:
generating a first public key and a first private key;
transferring the first public key to a certificate authority terminal;
hashing said file to provide a digital signature by using the first private key;
attaching a certificate received from the certificate authority terminal and the digital signature to said file; and
distributing to a client terminal said file as a communication package assimilated at least said file, the digital signature and the certificate by the recording device,
wherein the certificate received from the certificate authority includes the first public key and is encoded by using a second private key generated in the certificate authority terminal.
